(19) United States
(12) Patent Application Publication
(10) Pub. No.: US 2008/0225699 A1
(43) Pub. Date: Sep. 18, 2008

(54) Router and method of supporting nonstop packet forwarding on system redundant network

(76) Inventor: Min-Kyu Lee, Suwon-si (KR)

Correspondence Address: ROBERT E. BUSHNELL, 1522 K STREET NW, SUITE 300, WASHINGTON, DC, 20005-1202, US

(21) Appl. No.: 12/073,275

(22) Filed: Mar. 3, 2008

(30) Foreign Application Priority Data
Mar. 15, 2007 (KR) 10-2007-0025479

(51) Int. Cl. G06F 11/00; H04L 12/56

(52) U.S. Cl. 370/218; 370/389

(57) ABSTRACT

A router (i.e., an electrical circuit) and method of supporting nonstop packet forwarding on a system redundant network are provided. The method includes, when the router again operates, identifying whether or not the router is connected with a neighboring router; and when the router is identified connected with the neighboring router, transmitting a link-up signal to a link to connect to a host node.

### CLAIM OF PRIORITY

This application makes reference to and claims all benefits accruing under 35 U.S.C. § 119 from an application for ROUTER AND METHOD OF SUPPORTING NONSTOP PACKET FORWARDING ON SYSTEM REDUNDANT NETWORK earlier filed in the Korean Intellectual Property Office on Mar. 15, 2007 and there duly assigned Serial No. 2007-0025479.

### BACKGROUND OF THE INVENTION

1. Field of the Invention

The present invention relates to a method and router for nonstop packet forwarding on a system redundant network, and more particularly, to a router and method of supporting nonstop packet forwarding on a network that is configured to support system redundancy.

2. Description of the Related Art

The Internet is a combination of networks connected by routers. During the travel from an origination to a destination, packets pass through multiple routers until reaching a node connecting to a destination network. In general, routers connect to several networks, receiving packets from the networks and forwarding the same to other networks.

A router directly designates a next-hop router using static routing or uses a dynamic routing protocol in order to seek a route to forward received packets to their destination.

Static routing is a way for a user to directly designate a next-hop router to receive a packet next in routing to forward the packet to a destination. A static route, set up by a user, is stored in a system, thereby preparing a static routing table to allow packet forwarding immediately when the system powers on and a link having a connection with a next-hop router goes up. Communication becomes possible through the static routing table.

Compared to dynamic routing, static routing increases the number of processing steps at the time of initial routing, but can determine a failure relatively promptly. A large-scale communication network, however, requires the dynamic routing because of a frequent change of a communication route or communication counterpart's environment. A key part of the Internet is realized by dynamic routing as well.

Dynamic routing is a way of automatically designating a next-hop router. For dynamic routing, routers have to communicate and exchange routing information with each other. Thus, a communication protocol is needed to define an inter-router communication method. This is called “dynamic routing protocol”. Typical dynamic routing protocols include Routing Information Protocol (RIP), Open Shortest Path First (OSPF), Intermediate System to Intermediate System (IS-IS), Border Gateway Protocol (BGP), etc.

In order to configure routing information using a dynamic routing protocol, routers generally have to communicate with neighboring routers in a method defined in the dynamic routing protocol. In the case of Routing Information Protocol (RIP), a periodic routing update message includes routing information. In the case of either Open Shortest Path First (OSPF), Intermediate System to Intermediate System (IS-IS), Border Gateway Protocol (BGP), etc., routers exchange diverse kinds of messages with neighboring routers, thereby acquiring routing information.

There is needed a communication time to acquire routing information from neighboring routers. For example, the following three processes are needed to communicate with neighboring routers by using open shortest path first (OSPF) protocol and to configure a routing table by using routing information acquired from the neighboring routers.

(1) In a neighborship creating process, a router exchanges a hello message with either a neighboring router or a specific router, creating neighborship.

(2) In a routing information forwarding process, the router forwards routing information by creating and exchanging a Link State Advertisement (LSA) message. The LSA message, which is a message that the router exchanges to manage a routing table, has cost information on a route with the neighboring router.

(3) In a routing table creating process, the routing table is created by using Shortest Path First (SPF) calculation.

A failure may take place while a system performs its own function. Thus, in preparation for cases where the system fails to perform its function, the system performing a key function and an inter-system communication protocol are redundantly configured such that two independent systems each performing the same function can connect with each other and perform the function in a redundant mode: one of those two independent systems is in active status and the other one is in standby status. This is called “system redundancy.” The greatest purpose of system redundancy is to provide a service without interrupting performing functions.

In a contemporary system redundant network which uses either an Equal Cost Multiple Path (ECMP) protocol or Virtual Router Redundancy Protocol (VRRP), during recovering from a failure or a reboot of a redundant router induced by system installation, software upgrade or other related operations, a predetermined time period is required for the router to exchange an Open Shortest Path First (OSPF) message with the neighboring router and receive the routing information from the neighboring router. Therefore, all packets that the redundant router receives from the host node cannot be forwarded normally but will become lost while the redundant router receives all routing information, and thus starting to communicate with the neighboring router on the OSPF network.

### SUMMARY OF THE INVENTION

It is, therefore, one object of the present invention to provide an improved method and system for packet forwarding in a router supporting system redundancy to solve the above stated problems.

It is another object of the present invention to provide a method and system for, when a redundant router recovers from a failure or when a redundant router is re-booted in a system redundant network, forwarding a packet nonstop by solving a time delay occurring between a dynamic routing protocol and static routing and further, routing the packet with no loss.

According to an aspect of the invention for realizing the above objects, there is provided a method for nonstop packet forwarding in a router supporting system redundancy. The method includes, when the router again operates, identifying whether or not the router is connected with a neighboring router; and if the router is identified to be connected with the neighboring router, transmitting a link-up signal to a link to connect to a host node.

When either the router is re-booted or recovers from a failure, it may be identified whether or not the router is connected with the neighboring routers to which the router has to connect.

Preferably, a link-up signal is transmitted to a link other than the link to connect to the host node, immediately when the router is booted.

During transmitting the link-up signal to the host node, the link-up signal may be transmitted after a predetermined time lapses though the router is not connected with the neighboring router.

The method may further include a step of transmitting a link-down message to the host node when the router fails.

In the identifying whether or not the router is connected with the neighboring router, connectivity may be identified by sending an Internet Control Message Protocol (ICMP) request message to the neighboring router and receiving an Internet Control Message Protocol (ICMP) response message from the neighboring router in response to the Internet Control Message Protocol (ICMP) request message.

The method may further include a step of transmitting packets to the router when the host node receives a link-up signal.

According to another aspect of the invention for realizing the above objects, the invention provides a router including a neighboring-router manager, a router controller, and a connectivity identifier. The neighboring-router manager stores information on neighboring routers to which the router has to connect and information on a link to transmit a link-up signal after the router is connected to the neighboring router. The router controller inquires the neighboring-router manager and acquires information on the neighboring routers to which the router has to connect. The connectivity identifier identifies whether or not the router is connected to the neighboring routers.

The neighboring-router manager may configure a neighboring router management table for storing information on the neighboring routers to which the router has to connect, information on the link to transmit a link-up signal after the router is connected to the neighboring router, and information on the maximum delay time taken to delay the transmission of the link-up signal.

The router controller may transmit a link-up signal to the link to connect to the host node when the router is connected to the neighboring router.

Immediately when the router is booted up, the router controller may transmit a link-up signal to a link other than the link to connect to the host node, without identifying whether or not the router is connected to the neighboring router.

After the lapse of a predetermined time, the router controller may transmit a link-up signal though the router is not connected with the neighboring router.

The connectivity identifier may identify connectivity by sending an Internet Control Message Protocol (ICMP) request message to the neighboring router and receiving an Internet Control Message Protocol (ICMP) response message from the neighboring router in response to the Internet Control Message Protocol (ICMP) request message.

The router may further include a link signal processor and a data traffic processor. The link signal processor receives a link-up signal from the router controller and forwards the received link-up signal to the host node. The data traffic processor routes packets to the neighboring router with reference to a routing table.

According to a further another aspect of the invention for realizing the above objects, the invention provides a network supporting system redundancy. The network includes a router, a host node, and a neighboring router. The router acquires information on neighboring routers to which the router has to connect and transmits a link-up signal to a link to connect to the host node if it is identified that the router is connected to the neighboring routers. The host node starts to transmit a packet to the router when receiving the link-up signal. The neighboring router communicates with the router and exchanges routing information.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating a construction of a contemporary network of supporting system redundancy;

FIG. 2 is a ladder diagram illustrating a contemporary process of booting a redundant router;

FIG. 3A is a diagram illustrating a construction of a contemporary system redundant network using Equal Cost Multiple Path (ECMP);

FIG. 3B is a diagram illustrating a contemporary routing process when the network as shown in FIG. 3A fails;

FIG. 3C is a diagram illustrating a contemporary routing process when the network as shown in FIG. 3B recovers from a failure;

FIG. 4A is a diagram illustrating a construction of a contemporary system redundant network by using Virtual Router Redundancy Protocol (VRRP);

FIG. 4B is a diagram illustrating a contemporary routing process when the network shown in FIG. 4A fails;

FIG. 4C is a diagram illustrating a contemporary routing process when the network as shown in FIG. 4B recovers from a failure;

FIG. 5 is a diagram illustrating a construction of a network supporting system redundancy constructed according to the present invention;

FIG. 6 is a diagram illustrating a construction of a neighboring router management table managed by a redundant router constructed according to the principle of the present invention;

FIG. 7 is a ladder diagram illustrating a process of booting a redundant router constructed according to the principle of the present invention; and

FIGS. 8A and 8B are ladder diagrams illustrating exchange of signals and packets forwarding immediately after the redundant router recovering from an operational failure and showing a comparison between the contemporary method and the principles of the present invention.

### DETAILED DESCRIPTION OF THE PREFERRED EMBODIMENTS

The present invention will now be described more fully hereinafter with reference to the accompanying drawings, in which preferred embodiments of a method and system for nonstop packet forwarding on a system redundant network of the invention are shown.

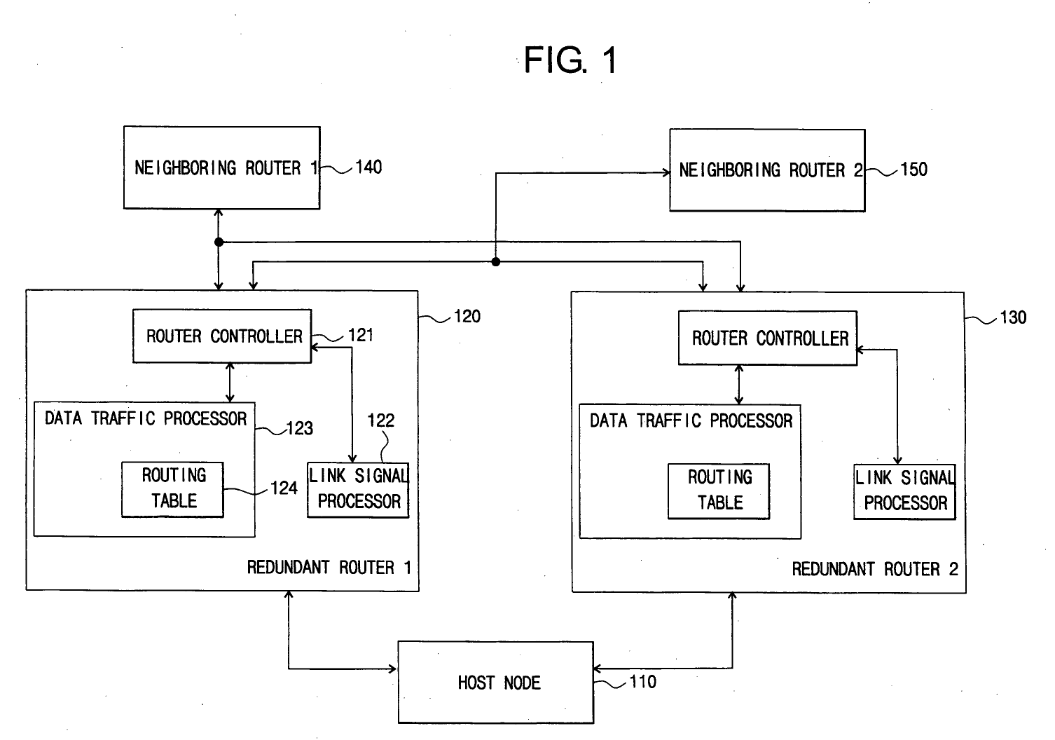

The contemporary methods and routers for forwarding packets on a system redundant network will be firstly described in details with reference to FIGS. 1-4C.

FIG. 1 is a diagram illustrating a construction of a contemporary network of supporting system redundancy.

The network includes a host node 110, a redundant router 1 120, a redundant router 2 130, a neighboring router 1 140, and a neighboring router 2 150.

Host node 110 sets a priority order between redundant router 1 120 and redundant router 2 130, defining an active router and a standby router. The redundant router with priority is the master router. In this case, host node 110 routes a packet to the master router. One of redundant routers 1 and 2 is a master router, and another one is a slave router. The redundant router other than the master router is called “a slave router” or “a backup router.” When the master router fails, the slave router being in a standby state operates as the master router. Host node 110 starts to transmit a packet to a data traffic processor 123 when receiving a link-up signal from a link signal processor 122.

Redundant router 1 120 supports system redundancy. Redundant router 1 120 includes a router controller 121, link signal processor 122, and data traffic controller 123. Data traffic processor 123 includes a routing table 124.

Router controller 121 transmits a link-up signal to link signal processor 122 when redundant router 1 120 is activated. Router controller 121 collects routing information from neighboring routers 140 and 150, manages the collected routing information, and updates routing table 124 with reference to the routing information. Router controller 121 deletes information on neighboring routers 140 and 150 from routing table 124 when neighboring routers 140 and 150 lose adjacency or fail.

Link signal processor 122 forwards a link-up signal received from router controller 121 to host node 110.

Data traffic processor 123 routes packets to neighboring routers 140 and 150 with reference to routing table 124. Routing table 124 configures and stores packet routing information in an entry form.

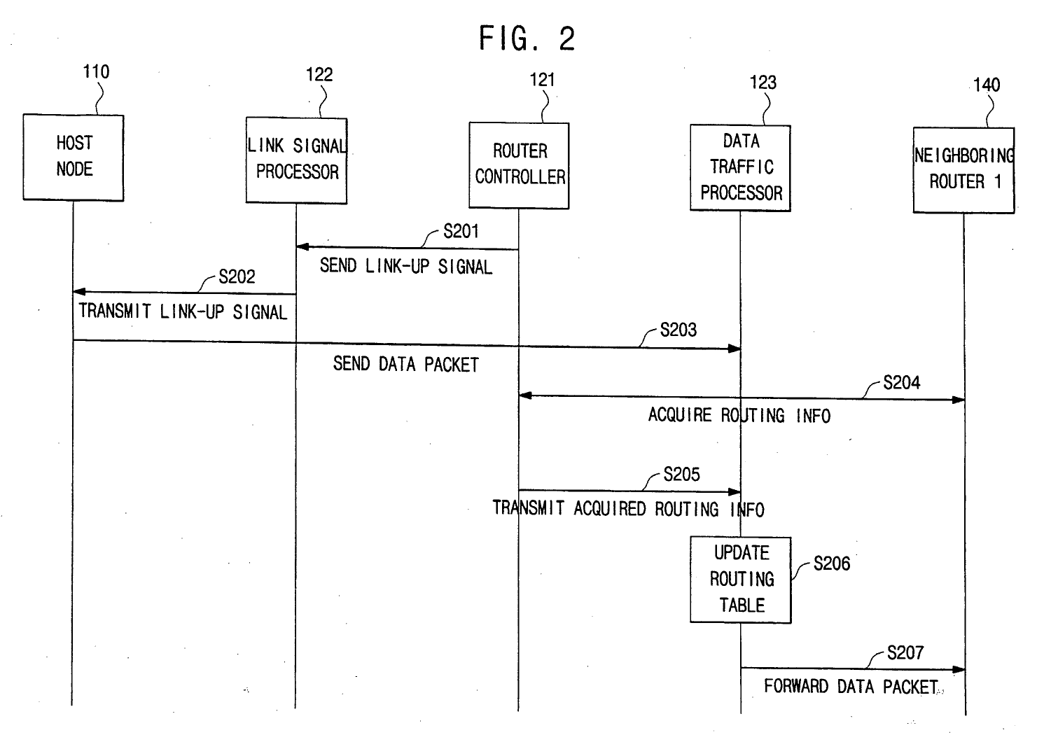

FIG. 2 is a ladder diagram illustrating a contemporary process of booting a redundant router.

It is assumed that redundant router 1 120 stops an operation when functional failure occurs and performs re-booting when recovering in the redundant system as shown in FIG. 1.

If router controller 121 determines that redundant router 1 120 is activated and can communicate with neighboring routers 140 and 150, router controller 121 sends a link-up signal to link signal processor 122 (S201). Link signal processor 122 transmits the received link-up signal to host node 110 (S202).

Upon receiving the link-up signal, host node 110 determines that redundant router 1 120 is activated and starts to send a data packet to data traffic processor 123 (S203).

Router controller 121 communicates with neighboring router 1 140 and acquires routing information from neighboring router 1 140 (S204). Router controller 121 transmits the acquired routing information to data traffic processor 123 (S205). Data traffic processor 123 updates routing table 124 with reference to the received routing information (S206).

Data traffic processor 123 forwards the data packet to neighboring router 1 140 with reference to updated routing table 124 (S207).

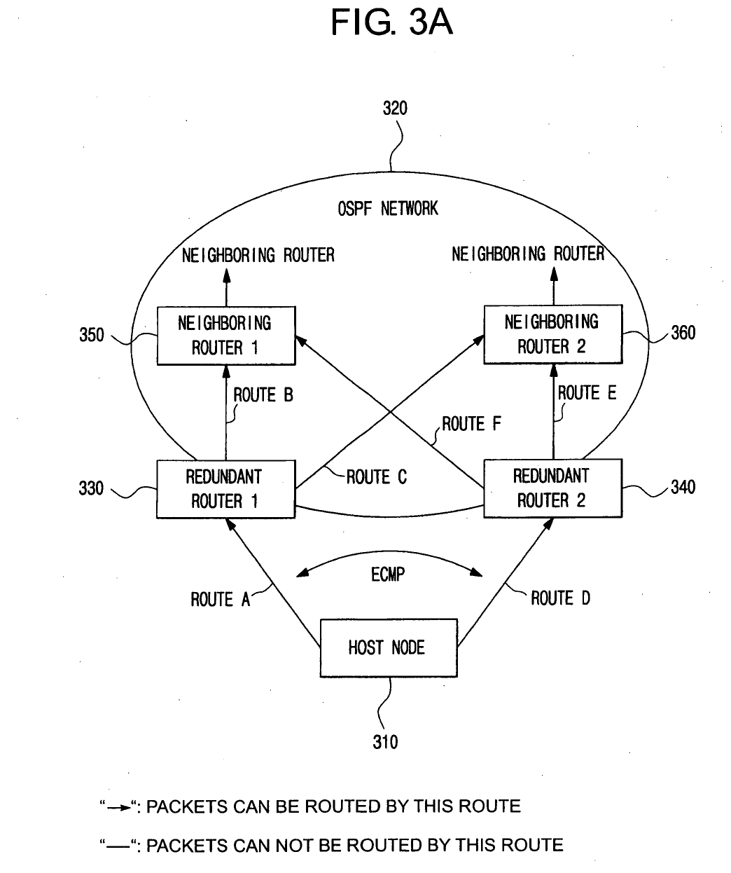

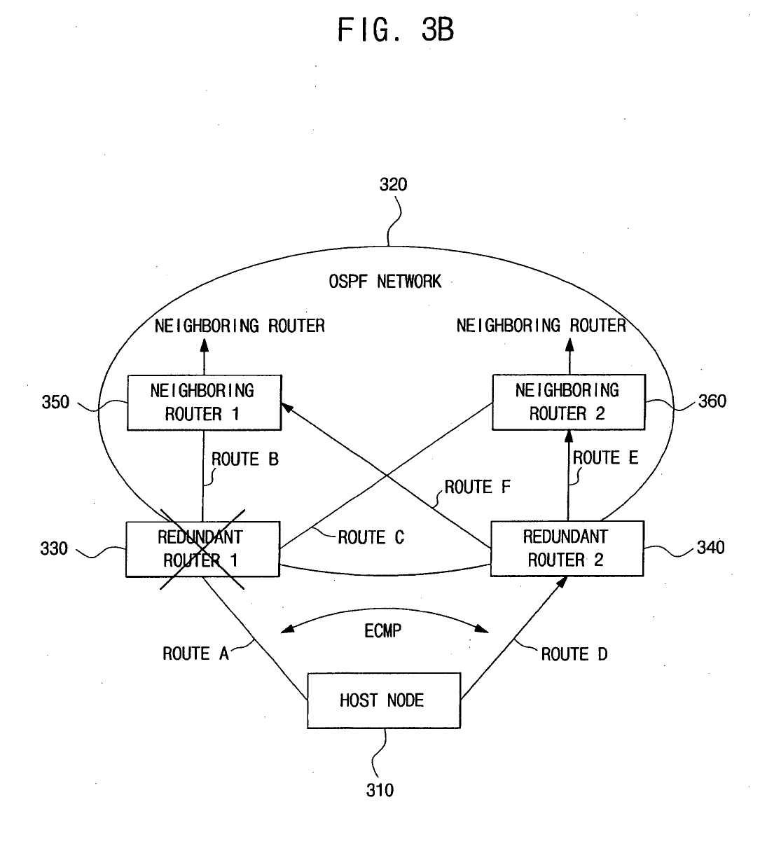

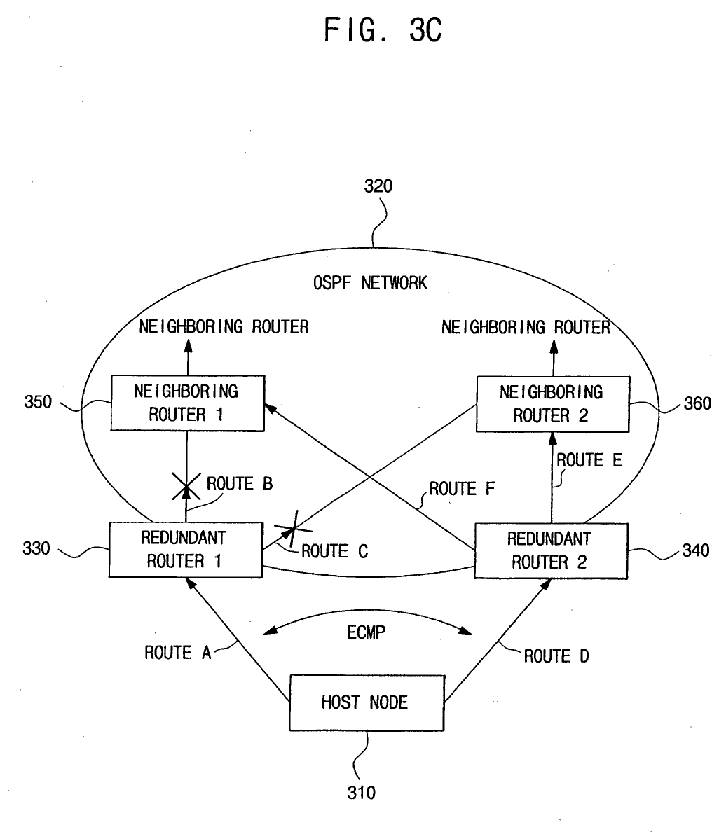

FIG. 3A is a diagram illustrating a construction of a contemporary system redundant network by using an Equal Cost Multiple Path (ECMP) protocol.

Equal Cost Multiple Path (ECMP) protocol is a protocol defining all equivalent routes to a destination. Equal Cost Multiple Path (ECMP) calculates all equivalent routes to a given destination when a shortest route table is prepared and distributes the same amount of traffic to the calculated equivalent routes if there are the calculated equivalent routes.

A host node 310, at a network terminal, sets up a static route that concurrently uses a redundant router 1 330 and a redundant router 2 340 as gateway routers. For example, a route A and a route D as shown in FIG. 3A are static routes by using static routing.

Among all of the packets transmitted from host node 310, some packets are routed through redundant router 1 330 and the others are routed through redundant router 2 340.

Routing information is shared among routers by using Open Shortest Path First (OSPF) protocol. Redundant router 1 330 routes a packet either through a route B or through a route C using Open Shortest Path First (OSPF) protocol. Redundant router 2 340 routes a packet either through a route E or through a route F. The network including redundant router 1 330, redundant router 2 340, a neighboring router 1 350, and a neighboring router 2 360 is an open shortest path first (OSPF) network 320 because the network shares the routing information using open shortest path first (OSPF) protocol.

FIG. 3B is a diagram illustrating a contemporary routing process when the network as shown in FIG. 3A fails.

If redundant router 1 330 fails or redundant router 1 330 is reset for more or less board installation or program upgrade, route A goes down. At this time, redundant router 2 340 serves as a gateway router for a predetermined time, thus all packets transmitted from host node 310 are routed through redundant router 2 340.

All of the packets are forwarded through route E and route F set up by redundant router 2 340. The packets, however, cannot be routed through route B and route C because redundant router 1 330 fails and cannot communicate with the neighboring routers.

FIG. 3C is a diagram illustrating a contemporary routing process when the network as shown in FIG. 3B recovers from a failure.

After lapse of a predetermined time, redundant router 1 330 recovers from a failure or a system booting is completed, and thus allowing route A to go up. If so, redundant router 1 330 and redundant router 2 340 concurrently again serve as gateway routers of host node 310. Thus, some of packets transmitted from host node 310 are forwarded to redundant router 1 330.

Redundant router 1 330 has to be aware of routing information of neighboring routers 350 and 360 in order to route a packet. Because open shortest path first (OSPF) is set between the routers, however, it takes a constant time for the router to exchange an Open Shortest Path First (OSPF) message with the neighboring router and receive the routing information from the neighboring router. For example, in the case of using Open Shortest Path First (OSPF) basic setting of Cisco, a time period of approximate 40 seconds to 1 minute is taken.

Therefore, all packets that redundant router 1 330 receives from host node 310 cannot be normally forwarded, while redundant router 1 330 starts communicating with the neighboring router on the Open Shortest Path First (OSPF) network and receives all of the routing information within the predetermined time period. Therefore, in this time period, the packets still cannot be routed through route B and route C.

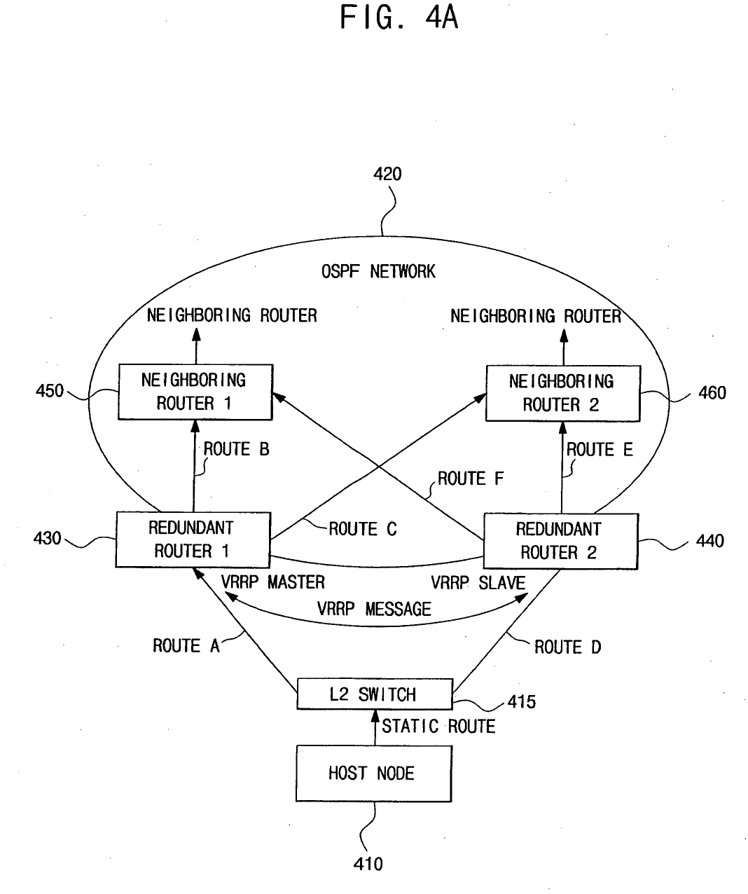

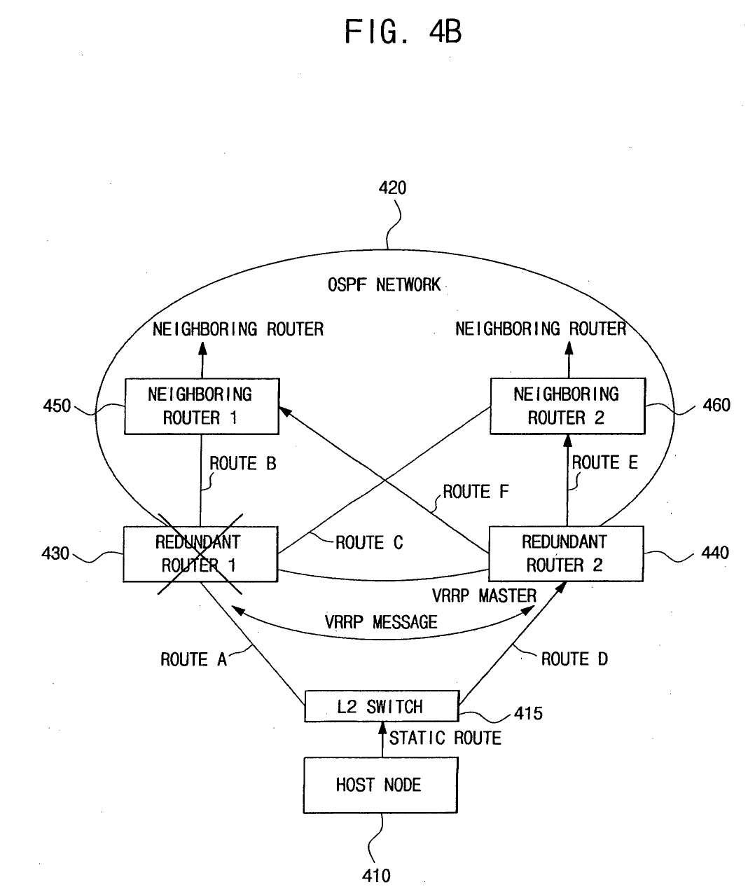

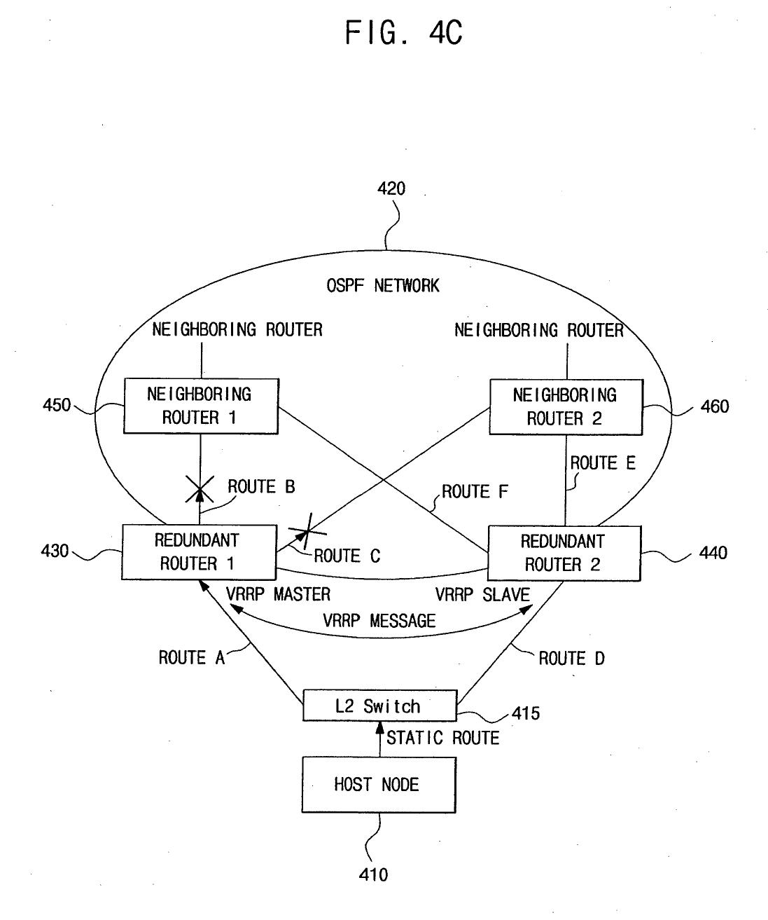

FIG. 4A is a diagram illustrating a construction of a contemporary system redundant network using Virtual Router Redundancy Protocol (VRRP).

In FIG. 4A, it is assumed that routers share routing information by using Open Shortest Path First (OSPF) protocol in a Open Shortest Path First (OSPF) network 420, and a master router and a slave router are chosen from a redundant router 1 430 and a redundant router 2 440 by using Virtual Router Redundancy Protocol (VRRP). Hot Standby Router Protocol (HSRP), which is a redundancy protocol, may be used instead of Virtual Router Redundancy Protocol (VRRP).

Virtual Router Redundancy Protocol (VRRP) is one kind of redundancy protocol. On the basis of the redundancy protocol, routers exchange a redundancy protocol message with each other, so one of routers is chosen as the master router serving as the master.

Basically, the master router periodically advertises itself that it is the master router to a slave router (backup router). The master router and the slave router may be distinguished by a priority order, so the router with a high priority value becomes the master router. A priority value is arbitrarily set by a user by the time the router is set up. If the router has a higher priority value than the other router, this router becomes the master router; and if the router has a lower priority value than the other router, this router becomes the backup router. The host node forwards a packet through the master router.

If the master router fails, the standby router serves as the master router. The slave router may judge whether or not the master router goes down from an advertisement message sent by the master router. If not receiving the advertisement message for a predetermined time (e.g., about three times an advertisement message transmission period of time), the slave router considers that the master router goes down, and is qualified for the master router, playing the role of the master router instead.

If the master router goes up and recovers a priority order later, however, the slave router again goes back into a standby state.

Host node 410 recognizes either redundant router 1 430 or redundant router 2 440 to serve as the Virtual Router Redundancy Protocol (VRRP) master router, as a gateway router, and forwards all packets to the Virtual Router Redundancy Protocol (VRRP) master router through a static route, i.e., L2 switch 415. L2 switch, i.e., layer two switch is a network device that forwards traffic based on MAC layer (Ethernet or Token Ring) addresses.

If redundant router 1 430 is set with a higher priority than that of redundant router 2 440, redundant router 1 430 operates as the Virtual Router Redundancy Protocol (VRRP) master router and redundant router 2 440 operates as the Virtual Router Redundancy Protocol (VRRP) slave router. Unlike FIG. 3a in which both redundant router 1 430 and redundant router 2 440 serve as gateway routers concurrently, in FIG. 4A, only the Virtual Router Redundancy Protocol (VRRP) master is recognized as the gateway router. Thus, no packet is forwarded to redundant router 2 440 through route D when redundant router 1 430 is active. All of the packets from host node 410 is forwarded to redundant router 1 430, passing through route A.

Neighboring router 1 450 and neighboring router 2 460 are similar to the redundant router 1 330 and redundant router 2 340 respectively.

FIG. 4B is a diagram illustrating a contemporary routing process when the network as shown in FIG. 4A fails.

If redundant router 1 430 fails or is re-booted for more/less system installation or software upgrade, route A goes down. Thus, redundant router 2 440 serves as the Virtual Router Redundancy Protocol (VRRP) master and all packets from host node 410 are forwarded to redundant router 2 440.

The packets may be forwarded through routes E and F set up by redundant router 2 440. No packets, however, can be routed through routes B and C because no packets are forwarded to redundant router 1 430 because redundant router 2 440 takes over the role of master router.

FIG. 4C is a diagram illustrating a contemporary routing process when the network as shown in FIG. 4B recovers from a failure.

Upon the lapse of a predetermined time, redundant router 1 430 recovers from a failure or system booting is completed, so redundant router 1 430 again normally operates. Thus, if route A goes up, redundant router 1 430 with a higher Virtual Router Redundancy Protocol (VRRP) priority again becomes the Virtual Router Redundancy Protocol (VRRP) master through a Virtual Router Redundancy Protocol (VRRP) message communication.

When redundant router 1 430 becomes the Virtual Router Redundancy Protocol (VRRP) mater, redundant router 1 430 receives all packets from host node 410. In order to route the packets, redundant router 1 430 has to be aware of routing information of the neighboring routers.

It however still takes a predetermined time period for redundant router 1 430 to exchange an Open Shortest Path First (OSPF) message with the neighboring router and receive routing information of the neighboring router. Accordingly, all packets that redundant router 1 430 receives from host node 410 cannot be transmitted normally but be lost while redundant router 1 430 receives all routing information, starting to communicate with the neighboring router on the Open Shortest Path First (OSPF) network.

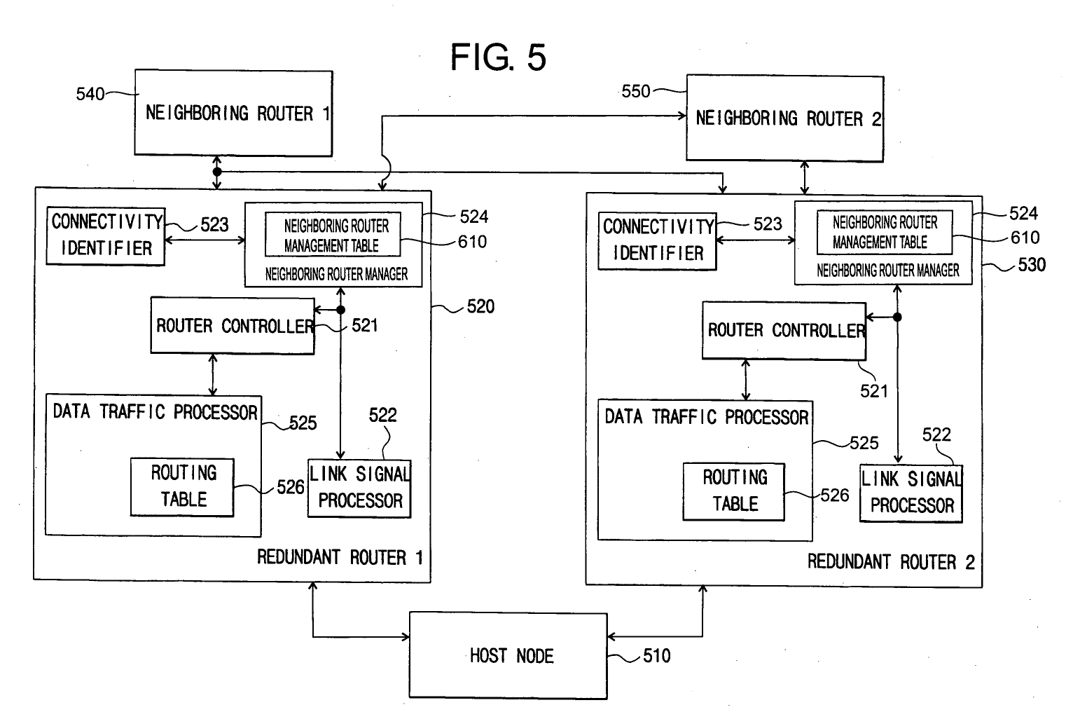

The embodiments of the present invention will now be described in details with reference to FIG. 5 to FIG. 7.

FIG. 5 is a diagram illustrating a construction of a network of supporting system redundancy according to the present invention.

In FIG. 5, it is assumed that a redundant router 1 520 has priority over a redundant router 2 530, operating as the master router. Redundant router 1 520 includes a router controller 521, a link signal processor 522, a connectivity identifier 523, a neighboring-router manager 524, and a data traffic processor 525. Data traffic processor 525 includes a routing table 526 to store routing information on a packet.

A construction of a network supporting system redundancy has been described in detail with reference to FIG. 1. Thus, the same description is omitted and a description aiming at a feature of the invention is made below.

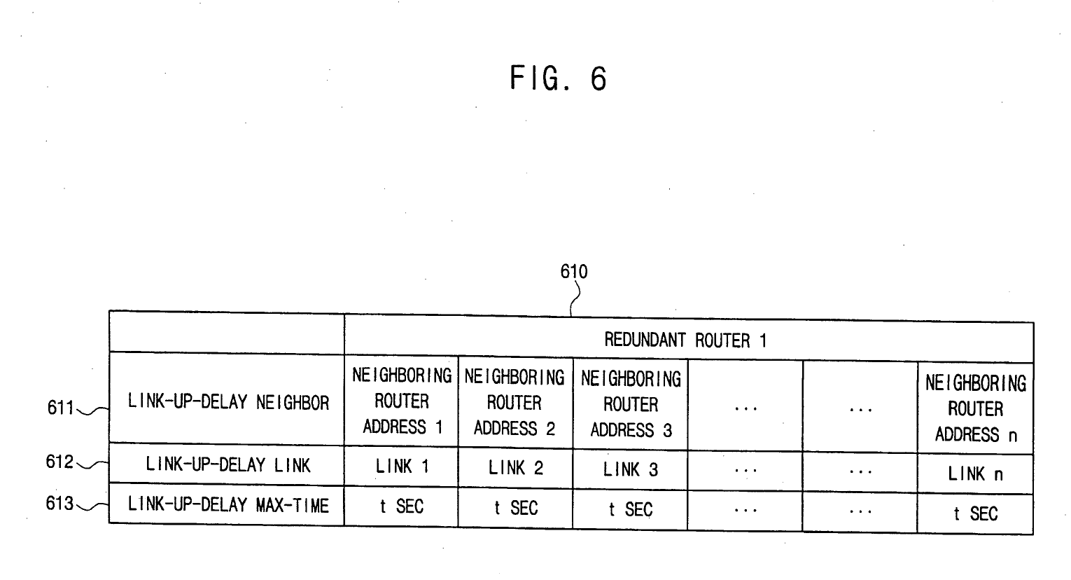

Router controller 521 inquires a neighboring router management table 610 stored in neighboring-router manager 524 and acquires a list of Internet Protocol (IP) addresses of neighboring routers to which a route may be set and information on a link to transmit a link-up signal at the time the redundant router is activated. Neighboring router management table 610 is described below in details with reference to FIG. 6. Router controller 521 receives a connection identification response message with a neighboring router from neighboring-router manager 524.

Upon receiving a connection identification request message from neighboring-router manager 524, connectivity identifier 523 sends an Internet Control Message Protocol (ICMP) request message to a neighboring router 1 540 or a neighboring router 2 550. After that, connectivity identifier 523 sends a connection identification response message to neighboring-router manager 524 when receiving an Internet Control Message Protocol (ICMP) response message from neighboring router 540 or 550.

Neighboring router manger 524 manages neighboring router management table 610 which store information on the neighboring routers. Upon receiving a connection identification response message from connectivity identifier 523, neighboring-router manager 524 transmits the connection identification response message to router controller 521.

Neighboring router 540 or 550 receives an Internet Control Message Protocol (ICMP) request message from connectivity identifier 523 and transmits an Internet Control Message Protocol (ICMP) response message to connectivity identifier 523 in response to the Internet Control Message Protocol (ICMP) request message.

FIG. 6 is a diagram illustrating a construction of a neighboring router management table managed by a redundant router constructed according to the present invention.

In cases where the router is re-booted or the router recovers from a failure, the present invention sets and stores a list of neighboring routers to which the router has to connect and transmits a link-up signal depending on whether or not there is routing information acquired from the neighboring routers, thereby enabling a communication with no packet loss.

In such a case, a delay time is caused between a dynamic routing protocol and static routing. In order to eliminate the time delay, the router transmits a link-up signal to a link connecting with a host node to enable static routing set to the host node, after being ready for forwarding packets through the dynamic routing protocol by exchanging routing information with neighboring routers using the dynamic routing protocol.

In details, unlike a contemporary art in which a router controller transmits a link-up signal to all links irrespective of a connection or disconnection from a neighboring router, in the present invention, either a connection or disconnection from the neighboring router that the router has to connect to is identified for a set link and then, a link-up signal is transmitted upon connection.

In order to determine whether or not the redundant router is ready to forward packets, the neighboring-router manager 524 configures neighboring router management table 610 using a management IP address of the neighboring router that communicates with the redundant router through a dynamic routing protocol.

The management IP address represents a representative IP address of a router. The management IP address may be generally set such that it is forwarded through a routing protocol. The redundant router previously stores a list of management IP addresses of neighboring routers to which routes may be set and information on a link to transmit a link-up signal at the time the redundant router is activated, in neighboring router management table 610.

FIG. 6 shows neighboring router management table 610. A format as shown in FIG. 6, however, is merely an example and hence, neighboring router management table 610 may be configured in any different set format.

Entries constituting neighboring router management table 610 are described, respectively, as below.

Link-up-delay neighbor 611 is an entry, which represents information on an address of a neighboring router that may exchange routing information with redundant router 1 520 and set a route constructed according to this routing information. The address of the neighboring router is a management IP address of the neighboring router to take routing information through a dynamic routing protocol. In the neighboring router management table 610 as shown in FIG. 6, the neighboring routers that can set a route with redundant router 1 520 are represented by “n” in number.

Link-up-delay link 612 is an entry, which arranges a link to transmit a link-up-signal after the link is possible to connect to an IP address of a neighboring router. In other words, this entry arranges a link to connect to host node 510 to which a static route is set.

Link-up signals are transmitted to all links other than the link arranged in link-up-delay link 612 immediately when the redundant router is booted, without identifying whether or not a redundant router is connected to an IP address of a neighboring router.

Link-up-delay max-time 613 is an entry, which represents the maximum delay time taken to delay the transmission of a link-up signal. In this example, all links are set with a maximum delay time of ‘t’ seconds.

The maximum delay time is set because the transmission of the link-up signal should not be delayed indefinitely at the time when a neighbor router fails or a link connection or setting is abnormal. After the set delay time lapses, the link-up signal is transmitted to a set link even though the redundant router is impossible to be connected to an IP address of a neighboring router.

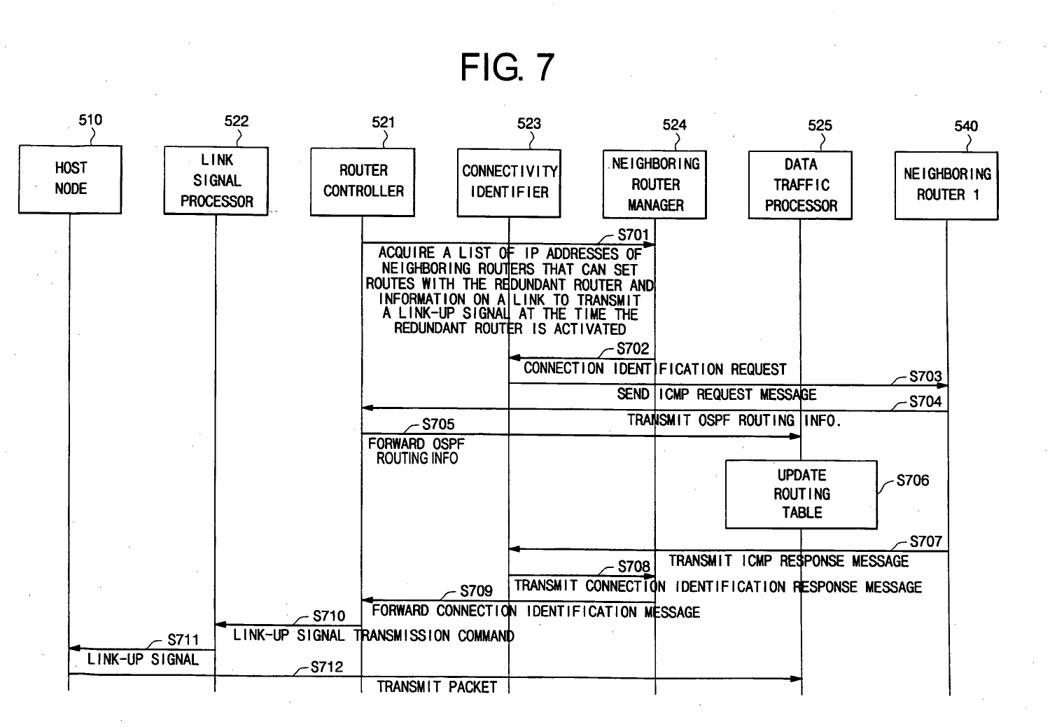

FIG. 7 is a ladder diagram illustrating a process of booting a redundant router constructed according to the present invention.

In the present invention, the process identifies that the redundant router is connected to a neighboring router when receiving an Internet Control Message Protocol (ICMP) response message from the neighboring router and transmits a link-up signal to a set link if the process identifies that the redundant router is connected to all set neighboring routers.

Upon receiving the link-up signal from link signal processor 522, host node 510 recognizes that a static route is valid and starts to transmit packets to a next-hop router of the static route.

Packets forwarded from host node 510 are processed by using the routing table of data traffic processor 525. Here, the packets may be normally forwarded through the neighboring router because there is the routing table previously built by a dynamic routing protocol communication with the neighboring router. The process is described as below in more details.

Router controller 521 inquires neighboring router management table 610 stored in neighboring-router manager 524 and acquires a list of Internet protocol (IP) addresses of neighboring routers that can set routes with the redundant router and information on a link to transmit a link-up signal at the time the redundant router is activated (S701).

Neighboring-router manager 524 sends a request of identifying a connection with the neighboring router corresponding to the IP address acquired in step 701 to connectivity identifier 523 (S702).

Connectivity identifier 523 sends an Internet Control Message Protocol (ICMP) request message to a neighboring router 1 540 (S703). Whether or not the neighboring router connects with the redundant router can be identified through the Internet Control Message Protocol (ICMP) request message sent to a management IP address of the neighboring router from the redundant router. Connection or disconnection can be also identified in different methods; however, Internet Control Message Protocol (ICMP) is a protocol which basically may be operated in a router even without particular settings. Upon receiving the Internet Control Message Protocol (ICMP) request message, the router sends an Internet Control Message Protocol (ICMP) response message in reply to the received Internet Control Message Protocol (ICMP) request message. Therefore, connectivity identifier 523 may identify whether or not the redundant router is connected to neighboring router 1 540 through the Internet Control Message Protocol (ICMP) request message.

Neighboring router 1 540 transmits Open Shortest Path First (OSPF) routing information to router controller 521 when receiving the Internet Control Message Protocol (ICMP) request message from the neighboring router (S704). Routing controller 521 forwards the received Open Shortest Path First (OSPF) routing information to data traffic processor 525 (S705). Data traffic processor 525 updates routing table 526 with reference to the Open Shortest Path First (OSPF) routing information (S706).

Neighboring router 1 540 sends an Internet Control Message Protocol (ICMP) response message to connectivity identifier 523 in reply to the Internet Control Message Protocol (ICMP) request message (S707).

Connectivity identifier 523 identifies that the redundant router connects with neighboring router 1 540 when receiving the Internet Control Message Protocol (ICMP) response message. Here, connectivity identifier 523 sends a connection identification response message to neighboring-router manager 524 (S708). The connection identification response message is a response to the request for identifying a connection with the neighboring router that is requested from neighboring-router manager 524 in step 702.

Neighboring-router manager 524 forwards a connection identification message to router controller 521 (S709). Router controller 521 sends a link-up signal transmission command to link signal processor 522 when receiving the connection identification message, identifying a connection with neighboring router 1 540 (S710). Link signal processor 522 transmits a link-up signal to host node 510 (S711).

Upon receiving the link-up signal, host node 510 recognizes the end of a communication between static routing and dynamic routing and starts to transmit packets to data traffic processor 525 (S712). Here, routing is already made between a static route and a dynamic route through a communication. Thus, a data packet may be transmitted without loss.

In addition to the time a system recovers from a failure or is re-booted, periodically, a table for identifying a connection with a neighboring router can be also identified and used to determine whether or not to transmit a link-down signal. If the router disconnects from the neighboring router, even the routing table in the data traffic processor is deleted. Hence, the router cannot forward packets normally. At this time, therefore, a link-down message is sent to the host node to induce packets to be transmitted to a different redundant router, thereby causing a remarkable reduction of packet loss. A subsequent process of re-connecting to the neighboring router, re-generating a routing table, and transmitting a link-up message to the host node is the same as the process described in FIG. 7.

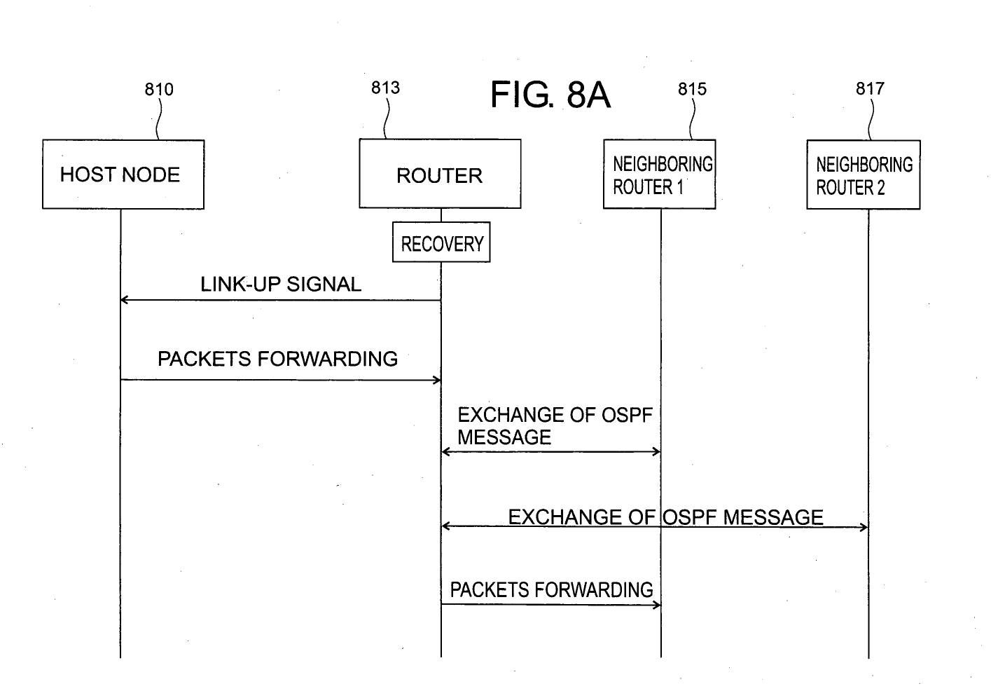

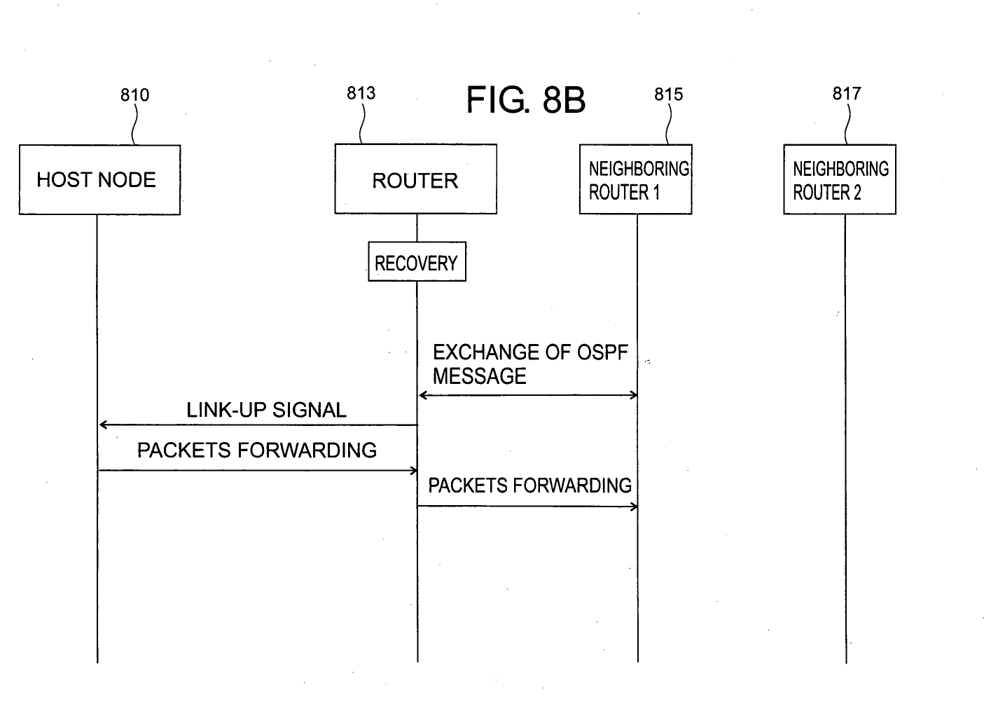

FIGS. 8A and 8B are ladder diagrams illustrating exchange of signals and packets forwarding immediately after the redundant router recovering from an operational failure and showing a comparison between the contemporary art and the present invention.

As shown in FIG. 8A, in the contemporary art, after router 813 recovers from an operational failure status, router 813 sends a link-up signal to host node 810, and host node 810 forwards packets to router 813. Then router 813 exchanges Open Shortest Path First (OSPF) message with all of the neighboring routers, i.e., neighboring router 1 815 and neighboring router 2 817. The time of exchange of Open Shortest Path First (OSPF) messages routers is relatively long, for example, in the case of using Open Shortest Path First (OSPF) basic setting of Cisco, approximate 40 seconds to 1 minute. During this time period, no packet is allowed to be transmitted between router 813 and neighboring routers. After the neighboring router 815 is designated to be the neighboring router to which router 813 should connect, router 813 forwards packets to neighboring router 1 815.

As shown in FIG. 8B, in the present invention, after router 813 recovers from an operational failure status, router 813 exchanges Open Shortest Path First (OSPF) message only with neighboring router 1 815. When router 813 connects with neighboring router 815, router 813 sends a link-up signal to host node 810 and host node 810 forwards packets to router 813. So, all packets that router 813 receives from the host node 810 cannot be lost but be transmitted normally while the router 813 receives all routing information, starting to communicate with the neighboring router 1 on the OSPF network.

According to the present invention, a communication can be performed without a packet loss even when the redundant router is re-booted or recovers from a failure on the system redundant network. This leads to the establishment of a redundant system that can perform communication without service interruption on the network. Further, when there is a possibility of a packet loss as a result of continuous identification of a link connection with the neighboring router, the redundant system is disabled, thereby supporting a better stable network service.

While the present invention has been shown and described in connection with the preferred embodiments, it will be apparent to those skilled in the art that modifications and variations can be made without departing from the spirit and scope of the invention as defined by the appended claims.

What is claimed is:

1. A method, comprising steps of:
when a router comes back to an operational status, determining whether the router is connected with a neighboring router; and
when the router is determined to be connected with the neighboring router, transmitting a link-up signal to a link to connect to a host node for forwarding packets in a router supporting system redundancy.

2. The method according to claim 1, further comprising:
when the router is re-booted or recovers from a failure, identifying whether or not the router is connected with the neighboring routers to which the router has to connect.

3. The method according to claim 1, further comprising:
transmitting a link-up signal to a link immediately after the router is booted up, and the link different from a link being connected to the host node.

4. The method according to claim 1, in which in the step of transmitting of the link-up signal to the host node, the link-up signal is transmitted after a predetermined time lapses though the router is not connected to the neighboring router.

5. The method according to claim 1, further comprising a step of transmitting a link-down message to the host node when the router fails.

6. The method according to claim 1, in which in the step of identifying whether or not the router is connected to the neighboring router, connectivity between the router and the neighboring router is identified by sending an Internet Control Message Protocol (ICMP) request message to the neighboring router and receiving an Internet Control Message Protocol (ICMP) response message from the neighboring router in response to the Internet Control Message Protocol (ICMP) request message.

7. The method according to claim 1, further comprising a step of transmitting packets to the router when the host node receives a link-up signal.

8. A router, comprising:
a neighboring-router manager storing information on neighboring routers to which the router has to connect and information on a link to transmit a link-up signal after the router is connected to the neighboring router;
a router controller inquiring the neighboring-router manager and acquiring information on the neighboring routers to which the router has to connect; and
a connectivity identifier identifying whether or not the router is connected to the neighboring routers.

9. The router according to claim 8, with the neighboring-router manager configuring a neighboring router management table for storing information on the neighboring routers to which the router has to connect, information on the link to transmit a link-up signal after the router is connected to the neighboring router, and information on the maximum delay time taken to delay the transmission of the link-up signal.

10. The router according to claim 8, with the router controller transmitting a first link-up signal to the link to connect to the host node when the router is connected to the neighboring router.

11. The router according to claim 8, in which immediately after the router is booted up, the router controller transmits a second link-up signal to a link other than the link to connect to the host node, without identifying whether or not the router is connected to the neighboring router.

12. The router according to claim 8, in which after a predetermined time lapses, the router controller transmits a link-up signal though the router is not connected to the neighboring router.

13. The router according to claim 8, in which the connectivity identifier identifies a connectivity by sending an Internet Control Message Protocol (ICMP) request message to the neighboring router and receiving an Internet Control Message Protocol (ICMP) response message from the neighboring router in response to the Internet Control Message Protocol (ICMP) request message.

14. The router according to claim 8, further comprising:
a link signal processor for receiving a link-up signal from the router controller and forwarding the received link-up signal to the host node; and
a data traffic processor for routing packets to the neighboring router with reference to a routing table.

15. A network supporting system redundancy, comprising:
a router acquiring information on neighboring routers to which the router has to connect and when the router is identified to be connected to the neighboring routers, transmitting a link-up signal to a link to connect to a host node;
the host node starting to transmit a packet to the router when receiving the link-up signal; and
the neighboring routers communicating with the router and exchanging routing information.

16. A method, comprising steps of:
acquiring, with the router, a list of Internet protocol (IP) addresses of neighboring routers that can set routes with the router and information on a link to transmit a link-up signal at the time the redundant router is activated;
sending, with the router, a request of identifying a connection to a neighboring router corresponding to the acquired IP address;
identifying, with the router, whether or not the router is connected to a neighboring router;
transmitting, with the router, a link-up signal to a host node; and
transmitting, with the host node, packets to the router in the router supporting system redundancy without packet loss and time delay.
